(19) United States
(12) Patent Application Publication
(10) Pub. No.: US 2024/0028357 A1
(43) Pub. Date: Jan. 25, 2024

(54) LARGE-SCALE TESTING AND SIMULATION

(71) Applicant: VMware, Inc., Palo Alto, CA (US)

(72) Inventors: Jian LAN, Beijing (CN); Liang CUI, Beijing (CN); Yan QI, Beijing (CN); Xiaoli TIE, Beijing (CN); Weiqing WU, Cupertino, CA (US); Aravind SRINIVASAN, Santa Clara, CA (US); Hemanth Kumar PANNEM, Cupertino, CA (US); Uday Suresh MASUREKAR, Sunnyvale, CA (US); Todd SABIN, Morganville, NJ (US)

(21) Appl. No.: 17/818,795

(22) Filed: Aug. 10, 2022

(30) Foreign Application Priority Data
Jul. 20, 2022 (WO) PCT/CN2022/106705

(51) Int. Cl. G06F 9/455; G06F 9/54

(52) U.S. Cl. CPC G06F 9/45558; G06F 9/45545; G06F 9/541

(57) ABSTRACT

The disclosure provides an approach for simulating a virtual environment. A method includes simulating, using a virtualization simulator, a plurality of hosts; simulating, using the virtualization simulator, a plurality of virtual computing instances (VCIs) associated with the plurality of simulated hosts, based on information obtained from a cluster application programming interface (API) provider; creating, using a virtualization simulator operator, one or more node simulator schedulers; creating, using the one or more node schedulers, a node simulator; simulating, using the node simulator, a plurality of guest operating systems (OSs) associated with the plurality of simulated VCIs; and joining the plurality of simulated guest OSs to one or more node clusters in a data center via an API server.

### RELATED APPLICATIONS

This application claims benefit of and priority to International Patent Cooperation Treaty Application No. PCT/CN2022/106705, filed Jul. 20, 2022, which is herein incorporated in its entirety by reference for all purposes.

### BACKGROUND

Computer virtualization is a technique that involves encapsulating a physical computing machine platform into virtual machine(s) (VM(s)) executing under control of virtualization software on a hardware computing platform or “host.” A VM provides virtual hardware abstractions for processor, memory, storage, and the like to a guest operating system (OS). The virtualization software, also referred to as a “hypervisor,” may include one or more virtual machine monitors (VMMs) to provide execution environment(s) for the VM(s).

Software defined networking (SDN) involves a plurality of physical hosts in communication over a physical network infrastructure of a data center (e.g., an on-premise data center or a cloud data center). The physical network to which the plurality of physical hosts are connected may be referred to as an underlay network. Each host has one or more virtualized endpoints such as VMs, containers, Docker containers, data compute nodes, isolated user space instances, namespace containers, or other virtual computing instances (VCIs). The VMs and/or other VCIs running on the hosts may communicate with each other using an overlay network established by hosts using a tunneling protocol. Though certain aspects are discussed herein with respect to VMs, it should be noted that the techniques may apply to other suitable VCIs as well.

Applications today are deployed onto a combination of VMs, containers, application services, and more. For deploying such applications, a container orchestrator (CO) provides a platform for automating deployment, scaling, and operations of application containers across clusters of hosts. One example of a container orchestrator is known as Kubernetes®. Kubernetes offers flexibility in application development and offers several useful tools for scaling.

In a Kubernetes system, containers are grouped into logical unit called “pods” that execute on nodes in a cluster (also referred to as “node cluster”). A node can be a physical server or a VM. In a typical deployment, a node includes an OS, such as Linux®, and a container engine executing on top of the OS that supports the containers of the pod. Containers in the same pod share the same resources and the same network, and the containers in the same pod maintain a degree of isolation from containers in other pods. The pods are distributed across nodes of the cluster, Kubernetes defines different built-in objects, like services and endpoints, in a single cluster. A user can leverage Kubernetes clusters to run modern microservice-based applications. Kubernetes also provides fine-grained access control via a network policy. Besides built-in objects, Kubernetes also provides custom resource definition (CRD). CRD allows the user to run any customized resource inside a cluster.

Simulators can be used to simulate a system in order to test and validate the system. For example, a simulator may run as an endpoint in a datacenter and test consumers of the system application programming interface (API). One example of an API-based simulator is VCSim made commercially available by VMware, Inc. of Palo Alto, CA. Such a simulator, in conjunction with a virtualization infrastructure manager, may simulate (or “mock”) a virtual environment for the purpose of, e.g., testing automation scripts or visualization tools, bug reproduction, or user interface experimentation and learning. The virtual environment may be “simulated” using object inventories and data structures to describe resources. These object inventories and data structures can then be exposed an objects managed by the virtualization manager API in the data center. Thus, simulated hosts and VCIs are not actual hosts and VCIs, but they can interface with the real data center. A simulation allows the data center to be simulated while requiring only a minimal amount of resources.

In a large system, including many nodes, multiple physical hosts may be used to deploy the nodes. Simulation and testing of such large systems may be challenging, as the simulator needs to simulate hypervisors, VMs, nodes, and customizations for many hosts.

One example of a large system is a virtualized telecommunications radio access network (vRAN). SDN is recently being used to virtualize telecommunications RANs, such as a 5G network. A RAN includes base stations, or node Bs (NBs), deployed at various locations to form a cellular network, which provides wireless access to mobile users. The NBs are composed of antennas, radio frequency (RF) equipment, digital processors, baseband units (BBUs), and remote radio heads (RRHs). The NBs interconnect signals between a user's device and a core network (e.g., a 5G Core and/or Evolved Packet Core). A signal arrives at the NB via an antenna and is retrieved by the RRH. The RRH creates an analog signal transmitted to the BBU. The BBU performs digital processing of the analog signal. For example, the BBU modulates, generates, and processes a digitized signal.

In a Distributed-RAN (D-RAN), (1) the BBUs and RRHs are both located at the cell site (e.g., a cell tower site), (2) the BBUs and RRHs may be directly connected, and (3) for every RRU, there is one BBU connected. In a Centralized-RAN (C-RAN), the NB is split up so that the RRUs are located at the cell site, while the BBUs are located in a centralized location (e.g., referred to as a hub site or BBU hotel). In C-RAN, multiple BBUs form a baseband pool that may be used to perform the digital processing and the networking, computing, and storage may be virtualized. In a virtualized C-RAN, each BBU may be a virtual node. The baseband pool may operate on one machine and the BBUs share the CPU, memory, and network resources.

Virtual telecommunications RANs (vRANs) may be offered as a Container-as-a-Service (CaaS). CaaS is a cloud service that manages containers at a large scale, including initializing stopping, scaling, and organizing containerized VMs. vRANs enable cloud service providers (CSPs) to run virtualized baseband functions that include virtualized Distributed Units (vDUs) and virtualized. Central Units (vCUs). A vDU and vCU may be components of a virtual base station (referred to herein as a cell site), which may be unitary or disaggregated.

A vRAN service provides infrastructure automation and orchestration. For example, the vRAN service may support distributed Kubernetes deployment from centralized management tooling, the ability to standardize the deployment of regional data centers and single host far edge cell site locations, and distributed RAN (D-RAN) and centralized RAN (C-RAN) deployments. A vRAN service may provide Container-as-a-Service (CaaS) management, including automated discovery, registration, and creation of Kubernetes clusters.

One example of an automation service is the Telco Cloud Automation (TCA) solution made commercially available by VMware, Inc. of Palo Alto, CA. TCA orchestrates workloads seamlessly from VM and container-based infrastructures. TCA modernizes the cloud to run containerized network function (CNFs) side-by-side with the consistent horizontal infrastructure and deploy the containerized CNFs throughout the RAN, from core to edge. TCA can be used to onboard and instantiate CNFs across tenants and clouds through pre-built integrations with Virtual Infrastructure Managers (VIMs) and Kubernetes. Components of a VIM may include a virtualization manager and/or a network manager. One example of a virtualization manager is the vCenter Server solution made commercially available by VMware, Inc. of Palo Alto, CA. One example of a network manager that provides advanced networking is the VMware NSX solution made commercially available by VMware, Inc. of Palo Alto, CA. A TCA-Control Plane (TCA-CP) provides infrastructure for placing workloads across clouds using TCA. The TCA-CP supports several types of VIMs and TCA connects with the TCA-CP to communicate with the VIM (e.g., the ICA may communicate with the network manager).

Accordingly, for a RAN CNF, a TCA platform may he built using microservices, containers, and Kubernetes to transition a legacy RAN infrastructure seamlessly to a cloud-native architecture with CaaS automation. For example, a 5G CNF pod may run on a customized Kubernetes node running inside a VM within a Kubernetes cluster. Cell site hosts may be managed by a virtualization manager (e.g., vCenterSub). Non-cell site hosts, located in other clusters in the cloud or in another on-premises datacenter, may be managed by another virtualization manager in the cloud (e.g., vCenterPrime).

To support RAN CNFs in cell sites, there are some customization items such as BIOS, firmware, driver, hypervisor, VM, guest operating system (OS), and Kubernetes pod tiers, which may need to be scaled to thousands of cell sites nodes. In an illustrative example, in a 5G CNF deployment with 134 national data center (NDC) hosts (two cell sites with sixty-seven hosts per cell site), 320 regional data center (RDC) hosts (eights cell sites with forty hosts per cell site), 320 breakout edge data center (BEDC) hosts (forty cell sites with eight hosts per cell site), and 4800 local data center (LDC) hosts (eight hundred cell sites with six hosts per cell site), TCA manages a total of 12,500 hosts.

Accordingly, to test a vRAN (e.g., to simulate virtual 5G RAN CNFs), the simulator may need to simulate thousands of hosts, VMs, and hypervisors (e.g., of the cell site hosts). The simulator may also need to simulate the associated BIOS (basic input/output system) settings and corresponding firmware, drivers, forward error correction (FEC) accelerator card, and precision time protocol (PTP) devices. Further, the simulator may need to simulate customizations, such as clone VMs, reconfigured VMs, powered on and powered off VMs, hosts queries to check the central processing unit (CPU) model, peripheral interconnect (PCI) devices, VM CPU pinning, Kubernetes node CPU pinning, memory pinning, non-uniform memory access (NUMA) awareness, VM setting with single root input/output virtualization (SRIOV) network adapters, FEC SRIOV virtual function (VF) passthrough, etc. For a vRAN, these customizations may be done by API calls invoked by an operation, such as the Telco CaaS operator.

In addition, the simulator may need to simulate thousands of Kubernetes nodes and customizations, the kubeadm tool (e.g., to simulate a kubeadm join command that initializes a Kubernetes worker node and joins it to the cluster), the kubelet tool (e.g., the primary agent that runs on Kubernetes nodes and registers the node with the API server), kubelet pod event handling logic, and guest OS customization operations. Linux guest OS customizations may include real-time Linux, a data plane development kit (DPDK) kernel module, custom package installation for a StallD daemon (e.g., a program to prevent starvation of a Linux OS threads), a TuneD daemon (e.g., a containerized daemon that provides custom kernel tuning), and PTP.

Today, there is no end-to-end simulated system to simulate the hosts, VMs, nodes, virtualization manager, container orchestrator, customizations, and topology. A virtualization simulator may be used to simulate cell site hosts and a node simulator may be used to simulate cell site nodes, but there are several issues with such separate simulators that fail to simulate the complete system. For example, this is in part due to there being no bridge between the virtualization simulator and node simulator. That is, the virtualization simulator does not have knowledge of the cell site host topology, such as information about the VMs managed by the container orchestrator, the cell site's virtual switch(es), virtual port group(s), storage, bring your own image (BYOI) template, IP address management (IPAM), cluster API provider (e.g., CapV), cloud provider interface (CPI), and TCA components such as the cluster operator (e.g., the Kubernetes cluster operator that handles workload cluster lifecycle), the VM configuration operator, and the node configuration operator.

IPAM provides management of IP addresses, domain name system (DNS), and dynamic host configuration protocol (DHCP). Because the virtualization simulator does not have knowledge of the IPAM, there is no IPAM for simulated VMs. Accordingly, when a cluster API provider requests the virtualization simulator to create a clone VM, reconfigure a VM, or power on a VM, the virtualization simulator cannot set an IP address for the VM. Certain VMs (e.g., TKG workload VMs) require a DHCP server assign an IP address to the VM. Since there is no IPAM for this VM, the IP address and DNS name for this VM are manually set in the virtualization simulator. The cluster API provider manager can then proceed to assign a providerID (e.g., specifying a provider ID of the cellular network). The TKG CPI may fetch the providerID to send queries to the virtualization simulator to check the VM status and node taint (e.g., a property that allows a node to repel a set of pods) for Kubernetes nodes (e.g., running a simulated cell site).

Further, due to the absence of a bridge between the virtualization simulator and node simulator, when a cell site VM clone task is handled by the virtualization simulator, the cloud configuration which carries an authentication token (e.g., apiServerEndpoint token) and certificate hashes (e.g., caCertificateHashes) cannot be captured directly by the virtualization simulator. Hence, the token and hashes, which may be needed for a simulated node to join a target Kubernetes cluster, cannot be used by any other components.

### SUMMARY

The technology described herein provides a method of simulating a virtual environment. The method includes simulating, using a virtualization simulator, a plurality of hosts; simulating, using the virtualization simulator, a plurality of virtual computing instances (VCIs) associated with the plurality of simulated hosts, based on information obtained from a cluster application programming interface (API) provider; creating, using a virtualization simulator operator, one or more node simulator schedulers; creating, using the one or more node schedulers, a node simulator; simulating, using the node simulator, a plurality of guest operating systems (OSs) associated with the plurality of simulated VCIs; and joining the plurality of simulated guest OSs to one or more node clusters in a data center via an API server.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 depicts a block diagram of a data center, according to one or more embodiments.

FIG. 1A is a block diagram of a pod VM, according to one or more embodiments.

FIG. 2 is a block diagram of a container orchestrator, according to one or more embodiments.

FIG. 3 is a block diagram of a simulator in the data center, according to one or more embodiments.

FIGS. 4A-4B depict a block diagram of a workflow for a simulator with a bridge between a virtualization simulator and a node simulator, according to one or more embodiments.

FIG. 5 depicts a block diagram of a workflow for cell site node customization and performance measurement in a vRAN simulation, according to one or more embodiments.

FIG. 6 depicts a flow diagram illustrating example operations for large scale system simulation, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for large scale testing, simulation, and automation.

In certain embodiments, an approach is provided for a simulator that simulates a large scale system, such as including many hosts, VMs, Kubernetes nodes, and/or customizations.

In certain embodiments, the simulator includes a bridge between a virtualization simulator (e.g., vcsub simulator) and a node simulator (e.g., virtual kubelet or a light VM with kubeadm). In some embodiments, the virtualization simulator simulated hosts and VMs. In some embodiments, the virtualization simulator handles API calls to create simulated VMs associated with the hosts. The node simulator simulates nodes (e.g., Kubernetes nodes) running simulated guest operating systems (OSs). In some embodiments, the bridge associates the simulated nodes (e.g., simulated guest OSs) with the hosts and VMs simulated by the virtualization simulator. In some embodiments, the simulated host, VM, and guest OS can be used by automation service components to simulate a large system without further input from a user or administrator. Associating the hosts, VMs, and nodes enables vRAN and automation components (e.g., TKG and TCA operators) to treat the nodes and VMs as the same box, although the simulated nodes and VMs may be on different pods.

In certain embodiments, an approach is provided for a cloud native cell site simulator that simulates a large scale system including many cell sites. It should be understood that while aspects of the present disclosure are described with respect to simulation, testing, and automation of a virtualized telecommunication RAN including cell sites, hosts, VMs, Kubernetes nodes, and/or customizations, the aspects described herein may be used for simulation, testing, and automation of other large scale virtualized systems.

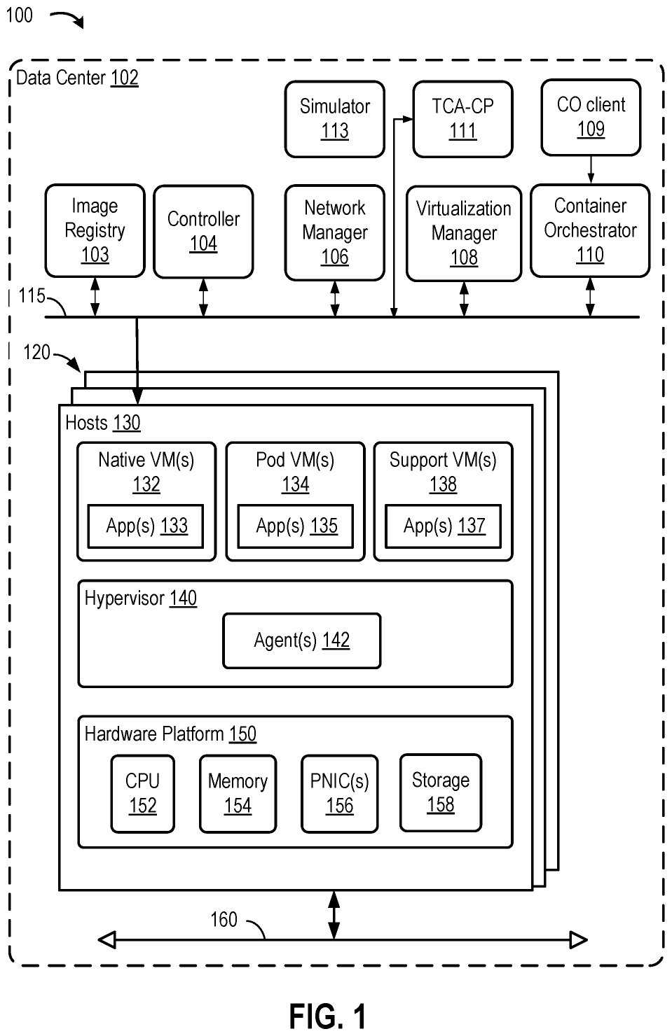

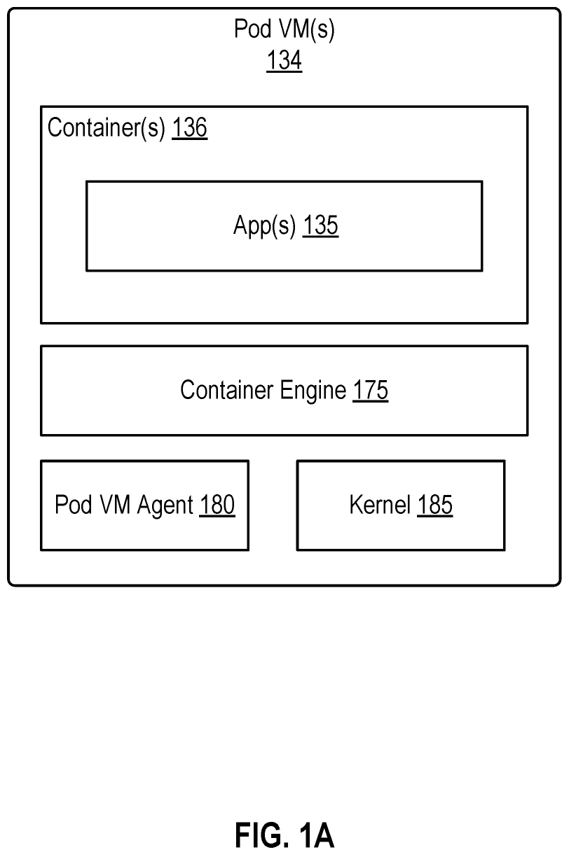

FIG. 1 depicts example physical and virtual network components in a networking environment 100 in which embodiments of the present disclosure may be implemented.

Networking environment 100 includes a data center 102. Data center 102 includes one or more hosts 130, a management network 115, a data network 160, a controller 104, a network manager 106, a virtualization manager 108, and a container orchestrator (CO) 110. Data network 160 and management network 115 may be implemented as separate physical networks or as separate virtual local area networks (VLANs) on the same physical network.

Data center 102 includes one or more clusters of hosts 130. Hosts 130 may be communicatively connected to data network 160 and management network 115. Data network 160 and management network 115 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 130 may be geographically co-located servers on the same rack or on different racks in any arbitrary location in the data center. Host(s) 130 are configured to provide a virtualization layer, also referred to as a hypervisor 140, that abstracts processor, memory, storage, and networking resources of a hardware platform 150 into multiple VMs (e.g., native VMs 132, pod VMs 134, and support VMs 138).

Host(s) 130 may be constructed on a server grade hardware platform 150, such as an x86 architecture platform. Hardware platform 150 of a host 130 may include components of a computing device such as one or more processors (CPUs) 152, memory 154, one or more network interfaces (e.g., PNICs 156), storage 158, and other components (not shown). A CPU 152 is configured to execute instructions, for example, executable instructions that perform one or more operations described herein and that may be stored in memory 154 and storage 158. PNICs 156 enable host 130 to communicate with other devices via a physical network, such as management network 115 and data network 160. In some embodiments, hosts 130 access a shared storage using PNICs 156. In another embodiment, each host 130 contains a host bus adapter (HBA) through which input/output operations (IOs) are sent to the shared storage (e.g., over a fibre channel (FC) network). A shared storage may include one or more storage arrays, such as a storage area network (SAN), network attached storage (NAS), or the like. The shared storage may comprise magnetic disks, solid-state disks, flash memory, and the like as well as combinations thereof. In some embodiments, the storage 158 (e.g., hard disk drives, solid-state drives, etc.) of host 130 can be aggregated and provisioned as part of a virtual SAN, which is another form of shared storage.

Hypervisor 140 architecture may vary. Virtualization software can be installed as system level software directly on the server hardware (often referred to as “bare metal” installation) and be conceptually interposed between the physical hardware and the guest operating systems executing in the virtual machines. Alternatively, the virtualization software may conceptually run “on top of” a conventional host operating system in the server. In some implementations, hypervisor 140 may comprise system level software as well as a “Domain 0” or “Root Partition” VM (not shown) which is a privileged machine that has access to the physical hardware resources of the host 130. In this implementation, one or more of a virtual switch, virtual router, virtual tunnel endpoint (VTEP), etc., along with hardware drivers, may reside in the privileged VM.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

The control plane determines the logical overlay network topology and maintains information about network entities such as logical switches, logical routers, and endpoints, etc. The logical topology information is translated by the control plane into network configuration data that is then communicated to network elements of host(s) 130. Controller 104 generally represents a control plane that manages configuration of VMs within data center 102. Controller 104 may be one of multiple controllers executing on various hosts 130 in data center 102 that together implement the functions of the control plane in a distributed manner. Controller 104 may be a computer program that resides and executes in a server in data center 102, external to data center 102 (e.g., such as in a public cloud), or, alternatively, controller 104 may run as a virtual appliance (e.g., a VM) in one of hosts 130. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of data center 102. Controller 104 communicates with hosts 130 via management network 115, such as through control plane protocols. In some embodiments, controller 104 implements a central control plane (CCP).

Network manager 106 and virtualization manager 108 generally represent components of a management plane comprising one or more computing devices responsible for receiving logical network configuration inputs, such as from a user or network administrator, defining one or more endpoints (e.g., VCIs) and the connections between the endpoints, as well as rules governing communications between various endpoints.

In some embodiments, virtualization manager 108 is a computer program that executes in a server in data center 102 (e.g., the same or a different server than the server on which network manager 106 executes), or alternatively, virtualization manager 108 runs in one of the VMs. Virtualization manager 108 is configured to carry out administrative tasks for data center 102, including managing hosts 130, managing VMs running within each host 130, provisioning VMs, transferring VMs from one host 130 to another host, transferring VMs between data centers, transferring application instances between VMs or between hosts 130, and load balancing among hosts 130 within data center 102. Virtualization manager 108 takes commands as to creation, migration, and deletion decisions of VMs and application instances on data center 102. However, virtualization manager 108 also makes independent decisions on management of local VMs and application instances, such as placement of VMs and application instances between hosts 130. In some embodiments, virtualization manager 108 also includes a migration component that performs migration of VMs between hosts 130, such as by live migration.

In some embodiments, network manager 106 is a computer program that executes in a server in networking environment 100, or alternatively, network manager 106 may run in a VM, e.g., in one of hosts 130. Network manager 106 communicates with host(s) 130 via management network 115. Network manager 106 may receive network configuration input from a user or an administrator and generates desired state data that specifies how a logical network should be implemented in the physical infrastructure of data center 102. Network manager 106 is configured to receive inputs from an administrator or other entity, e.g., via a web interface or application programming interface (API), and carry out administrative tasks for data center 102, including centralized network management and providing an aggregated system view for a user.

Data center 102 includes container orchestrator 110. In some examples, container orchestrator 110 is a Kubernetes container orchestrator. In embodiments, the virtualization layer of a host cluster 120 is integrated with an orchestration control plane, such as a Kubernetes control plane. Virtualization manager 108 may deploy container orchestrator 110. In embodiments, the Kubernetes control plane of the supervisor cluster is extended to support custom objects in addition to pods, such as VM objects that are implemented using native VMs 132 (as opposed to pod VMs 134). The orchestration control plane includes master server(s) with both pod VM controllers and native VM controllers. The pod VM controllers manage the lifecycles of pod VMs. The native VM controllers manage the lifecycles of native VMs executing in parallel to the pod VMs.

Virtualization manager 108 can enable a host cluster as a supervisor cluster and provide its functionality to development teams. In the example of FIG. 1, host cluster 120 is enabled as a “supervisor Cluster,” described further herein, and thus VMs executing on each host 130 include pod VMs 134 and native VMs 132. A “supervisor cluster” uses VMs to implement both control plane nodes having a Kubernetes control plane, and compute nodes managed by the control plane nodes. A pod VM 134 is a VM that includes a kernel and a container engine that supports execution of containers 136, as well as an agent (referred to as a pod VM agent) that cooperates with a controller of an orchestration control plane executing in hypervisor 140 (referred to as a pod VM controller). FIG. 1A is a block diagram of a pod VM 134, according to one or more embodiments. Each pod VM 134 has one or more containers 136 running therein in an execution space managed by container engine 175. The lifecycle of containers 136 is managed by pod VM agent 180. Both container engine 175 and pod VM agent 180 execute on top of a kernel 185 (e.g., a Linux® kernel).

Native VMs 132 and pod VMs 134 support applications 133, 135 deployed onto host cluster 120, which can include containerized applications 133 and 135, executing in pod VMs 134 and native VMs 132, and applications executing directly on guest OSs (non-containerized) (e.g., executing in native VMs 132). Support VMs 138 have specific functions within host Cluster 120. For example, support VMs 138 can provide control plane functions, edge transport functions, and/or the like.

In an embodiment, data center 102 further includes an image registry 103. Image registry 103 manages images and image repositories for use in supplying images for containerized applications. Containers of a supervisor host cluster 120 may execute in pod VMs 134. The containers in pod VMs 134 are spun up from container images managed by image registry 103.

As discussed herein, in a virtualized telecommunications RAN, RAN CNFs may run on Kubernetes nodes. In Kubernetes, a host cluster 120 may be a Kubernetes Cluster, hosts 130 become nodes of a Kubernetes cluster, and pod VMs 134 executing on hosts 130 implement Kubernetes pods. The orchestration control plane includes container orchestrator 110 and agents 142 (e.g., installed by virtualization manager 108 and/or network manager 106 in hypervisor 140 to add host 130 as a managed entity). Container orchestrator 110 may be a supervisor Kubernetes master and includes control plane components of Kubernetes, as well as custom controllers, custom plugins, scheduler extender, and the like that extend Kubernetes to interface with virtualization manager 108 and the virtualization layer. For purposes of clarity, container orchestrator 110 is shown as a separate logical entity. For practical implementations, container orchestrator 110 may be implemented as one or more native VM(s) 132 and/or pod VMs 134 in host cluster 120. Further, although only one container orchestrator 110 is shown, data center 102 can include more than one container orchestrator 110 in a logical cluster for redundancy and load balancing.

Data center 102 further includes container orchestrator (CO) client 109. CO client 109 provides an input interface for a user to container orchestrator 110. One example of a CO client 109 for Kubernetes is referred to as kubectl. Through CO client 109, the user can submit desired states of the Kubernetes system to CO 110. For example, kubectl can be used to deploy applications, inspect and manage cluster resources, and view logs. In embodiments, the user submits the desired states within the scope of a supervisor namespace. In Kubernetes, namespaces provide a scope for names of resources. Names of resources for namespace objects (e.g., (Deployments, Services) are unique within a narnespace. Kubernetes starts with four initial names: default (default namespace for object with no other namespace); kube-system (the namespace for objects created by the Kubernetes system); kube-public (a namespace readable by all users); and kube-node-lease (the namespace that holds lease objects associated with each node, where the lease allows sending of heartbeats to detect node failure). Each supervisor namespace provides resource-constrained and authorization-constrained units of multi-tenancy. A supervisor namespace provides resource constraints, user-access constraints, and policies (e.g., storage policies, network policies, etc.). Resource constraints can be expressed as quotas, limits, and the like with respect to compute (CPU and memory), storage, and networking of the virtualized infrastructure. User-access constraints include definitions of users, roles, permissions, bindings of roles to users, and the like. Each supervisor namespace is expressed within the orchestration control plane using a namespace native to the orchestration control plane (e.g., a Kubernetes namespace or generally a “native namespace”), which allows users to deploy applications in host cluster 120 within the scope of supervisor namespaces. In this manner, the user interacts with CO 110 to deploy applications in host cluster 120 within defined supervisor namespaces.

As shown, data center 102 may further include a TCA-CP 111. TCA CP 111 provides infrastructure for placing workloads across clouds using TCA. TCA-CP 111 may communicate with network manager 106 for TCA. In some embodiments, data center 102 further includes a workflow automation orchestrator.

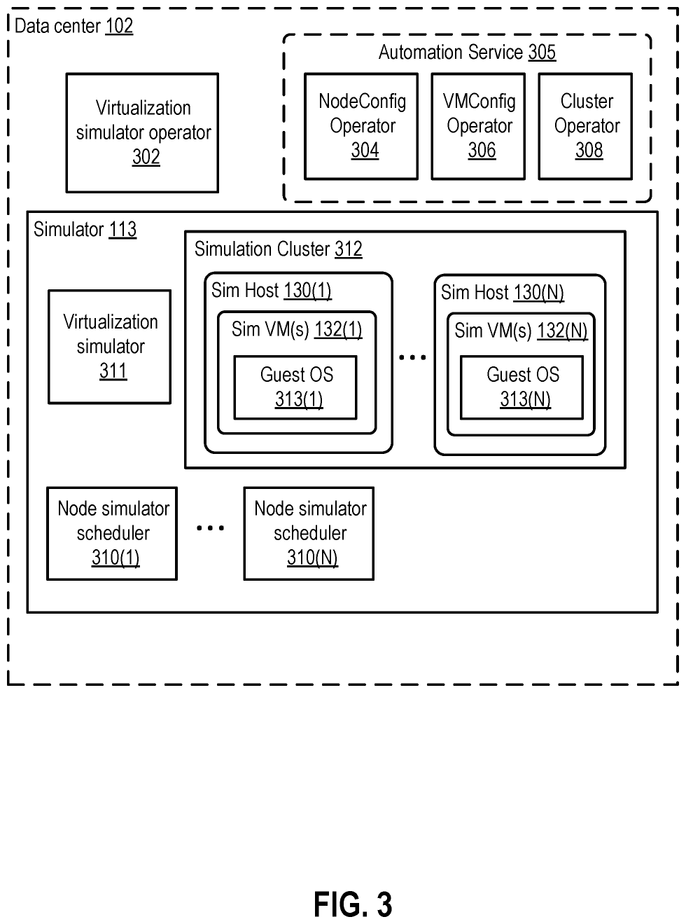

As shown, data center 102 may include a simulator 113. Simulator 113 may run on a host 130 in the data center 102. Simulator 113 may be used for simulation and validation. Simulator 113 is discussed in more detail below with respect to FIGS. 3-5.

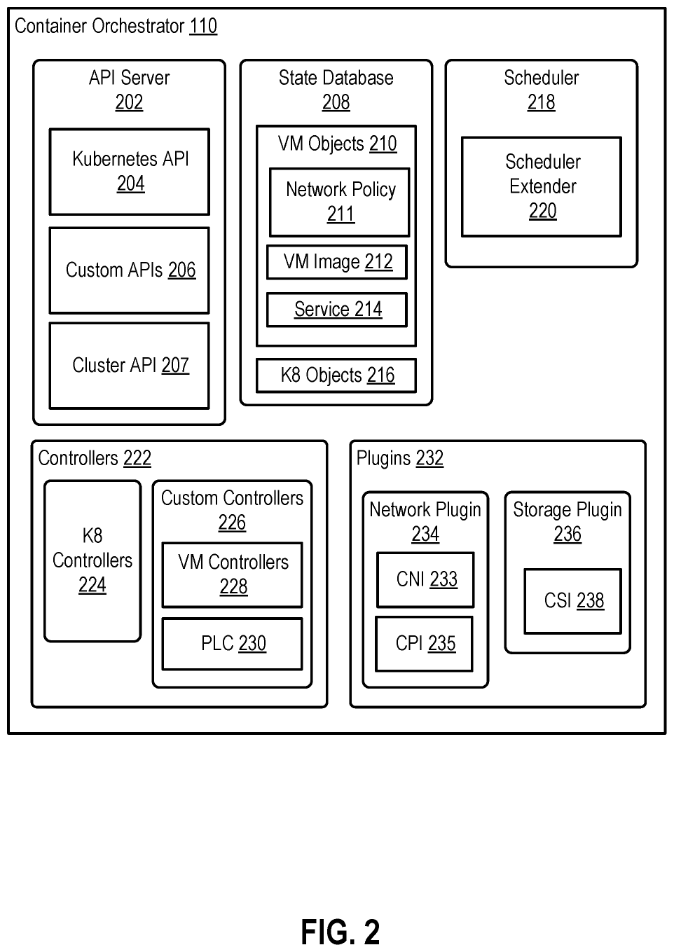

FIG. 2 is a block diagram of container orchestrator 110 (e.g., a supervisor Kubernetes master) according to an embodiment. As shown, CO 110 includes application programming interface (API) server 202, a state database 208, a scheduler 218, controllers 222, and plugins 232.

API server 202 includes Kubernetes API 204 and custom APIs 206. Custom APIs 206 are API extensions of Kubernetes API 204 using either a custom resource/operator extension pattern or the API extension server pattern. Custom APIs 206 are used to create and manage custom resources, such as VM objects. API server 202 allows a user or administrator to provide a declarative schema for creating, updating, deleting, and viewing objects. A declarative schema allows developers to declare a final desired state of a database and the system adjusts automatically to the declarative schema.

State database 208 stores information about the state of host cluster 120 as information about the objects created by API server 202. A user can provide application specification data to API server 202, the application specification data defining various objects supported by the API. The objects have specifications that represent the desired state. State database 208 stores the information about objects defined by application specification data as part of the supervisor cluster state. Standard Kubernetes objects 216 include namespaces, nodes, pods, configuration maps, and secrets, among others. Custom objects are resources defined through custom APIs 206 (e.g., VM objects 210). Namespaces provide scope for objects. Namespaces are objects themselves maintained in state database 208. A namespace can include resource quotas, limit ranges, role bindings, and/or the like that are applied to objects declared within its scope. Virtualization manager 108 and network manager 106 create and manage supervisor namespaces for host cluster 120. A supervisor namespace is a resource-constrained and authorization-constrained unit of multi-tenancy managed by virtualization manager 108. Namespaces inherit constraints from corresponding supervisor cluster namespaces. Config maps include configuration information for applications managed by CO 110. Secrets include sensitive information for use by applications managed by CO 110 (e.g., passwords, keys, tokens, etc.).

Controllers 222 can include, for example, standard Kubernetes controllers (e.g., K8 controllers 224) and/or custom controllers 226. Custom controllers 226 include controllers for managing lifecycles of Kubernetes objects 216 and custom objects. For example, custom controllers 226 can include VM controllers 228 configured to manage VM objects 210 and a pod VM lifecycle controller (PLC) 230 configured to manage pods. Controllers 222 tracks objects in state database 208 of at least one resource type. Custom controller(s) 226 are responsible for making the current state of host cluster 120 come closer to the desired state as stored in state database 208. A custom controller 226 can carry out action(s) by itself, send messages to API server 202 to have side effects, and/or interact with external systems.

Plugins 232 can include, for example, network plugin 234 and storage plugin 236. Plugins 232 provide a well-defined interface to replace a set of functionality of the Kubernetes control plane. Network plugin 234 is responsible for configuration of the network layer to deploy and configure the cluster network. Network plugin 234 cooperates with virtualization manager 108 and/or network manager 106 to deploy logical network services of the cluster network. Network plugin 234 also monitors state database for VM objects 210.

Kubernetes may use a Container Network Interface (CNI) to provide networking functionality to containers. Kubernetes may support various networking options via CNI 233. The CNI plugins may enable Kubernetes to add a container to the network, delete a container from the network, and check whether the container's network is as expected. Kubernetes may select a target pod VM 134 for a service. Once the target pod VM 134 is selected, the networking is facilitated by the CNI plugin.

Kubernetes may use a CPI 235 responsible for running cloud specific control loops to monitor the state of the system through the API server 202. CPI 235 may initiate changes if the declared state is different than the current state. When an application is deployed in Kubernetes, application definition (e.g., the declared end-state of the application) is persisted via the API server on a Kubernetes master node.

Storage plugin 236 is responsible for providing a standardized interface for persistent storage lifecycle and management to satisfy the needs of resources requiring persistent storage. Storage plugin 236 cooperates with virtualization manager 108 to implement the appropriate persistent storage volumes in a shared storage. CSI 238 exposes block and file storage systems to containerized workload in CO systems, such as Kubernetes.

Scheduler 218 monitors state database 208 for newly created pods with no assigned node. A pod is an object supported by API server 202 that is a group of one or more containers, with network and storage, and a specification on how to execute. Scheduler 218 selects candidate nodes in host cluster 120 for pods. Scheduler 218 cooperates with scheduler extender 220, which interfaces with virtualization management server 116. Scheduler extender 220 cooperates with virtualization manager 108 to select nodes from candidate sets of nodes and provide identities of hosts 130 corresponding to the selected nodes. For each pod, scheduler 218 also converts the pod specification to a pod VM specification, and scheduler extender 220 asks virtualization manager 108 to reserve a pod VM on the selected host 130.

Scheduler 218 updates pods in state database 208 with host identifiers. Kubernetes API 204, state database 208, scheduler 218, and Kubernetes controllers 224 comprise standard components of a Kubernetes system executing on host cluster 120.

Custom controllers 226, plugins 232, and scheduler extender 220 comprise custom components of CO 110 that integrate the Kubernetes system with host cluster 120 and virtualization manager 108.

Custom APIs 206 enable developers to discover available content and to import existing VMs as new images within their Kubernetes Namespace. VM objects 210 that can be specified through custom APIs 206 include VM resources, VM image resources 212, VM profile resources, network policy resources 211, network resources, and service resources 214. In some embodiments, CO 110 includes a cluster API 207. In some embodiments, the cluster API 207 is a TKG CapV. Cluster API 207 may expand the capabilities of Kubernetes by offering an interface with cloud providers for provisioning of Kubernetes workload clusters. A CRD and cluster API 207 may be used to create a Kubernetes management cluster using kubeadm to communicate with the cloud providers in order to deploy nodes and VMs and create clusters on a cloud provider.

VM image resource 212 enables discovery of available images for consumption via custom APIs 206. VM image resource 212 exposes verbs such as image listing, filtering and import so that the developer can manage the lifecycle and consumption of images. A single VM image resource 212 describes a reference to an existing VM template image in a repository.

A VM profile resource (not shown) is a resource that describes a curated set of VM attributes that can be used to instantiate native VMs. A VM profile resource gives the virtualization manager 108 administrator control over the configuration and policy of the native VMs that are available to the developer. The administrator can define a set of available VM profile resources available in each namespace. The administrator can create new profiles to balance the requirements of the administrator, the developer and those imposed by the underlying hardware. A VM profile resource enables definition of classes of information such as virtual CPU and memory capacity exposed to the native VM, resource, availability and compute policy for the native VM, and special hardware resources (e.g. FPGA, pmem, vGPU, etc.) available to the VM profile.

A network resource (not shown) represents a single network to be consumed by a native VM. In embodiments, a network resource is a simple resource, abstracting the details of an underlying virtual port group that the network represents. For example, a network resource may be one of the following types: standard port group, distributed port group, or tier 1 logical router in the network layer, and/or the like. The available networks are configured by the administrator for each namespace via a network policy resource 211. Network resources are used to attach additional network interfaces to a specific virtual network.

Service resource 214 binds native VM instances to Kubernetes services in order to expose a network service from a native VM 132 to pod VMs 134 and other native VMs 132. In embodiments, service resource 214 includes a label selector that is used to match any labels applied to any VM resource. Once a service resource 214 and a VM resource have been coupled, a delegate service and endpoints resource is installed in order to enable network access to the native VM 132 via the service DNS name or IP address.

A VM resource (not shown) may combine all of the above resources to generate a desired native VM 132. In embodiments, a VM resource specifies a VM image resource 212 to use as the master image. VM resources specify a configuration that is mapped to underlying infrastructure features by VM controllers 228, including, but not limited to, VM Name, Virtual Resource Capacity, Network to Virtual NIC binding, DNS Configuration, Volume Customization, VM Customization scripts and VM Placement and Affinity policy.

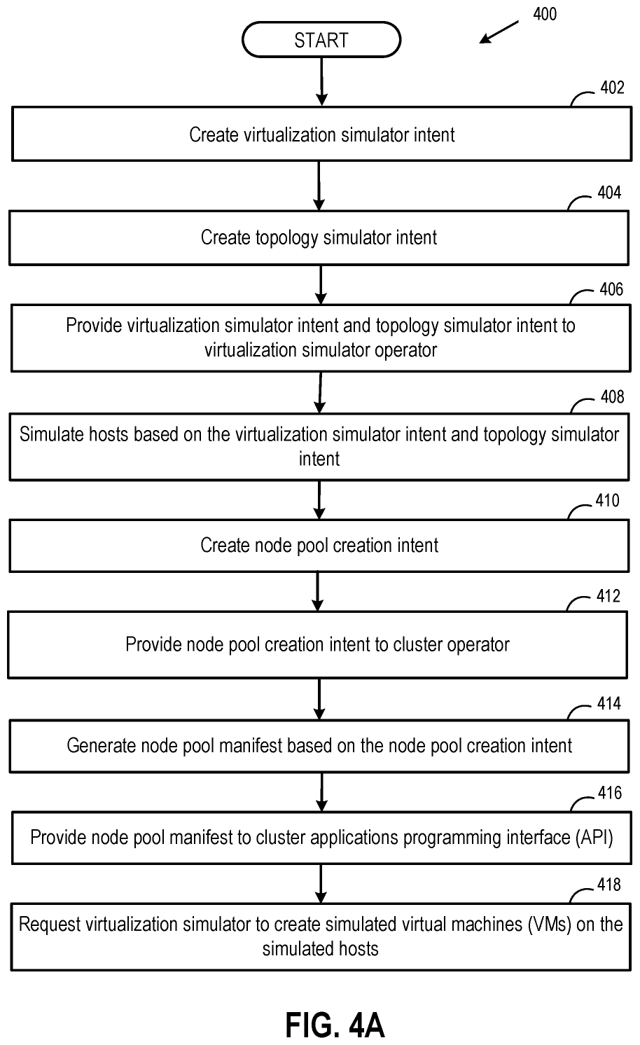

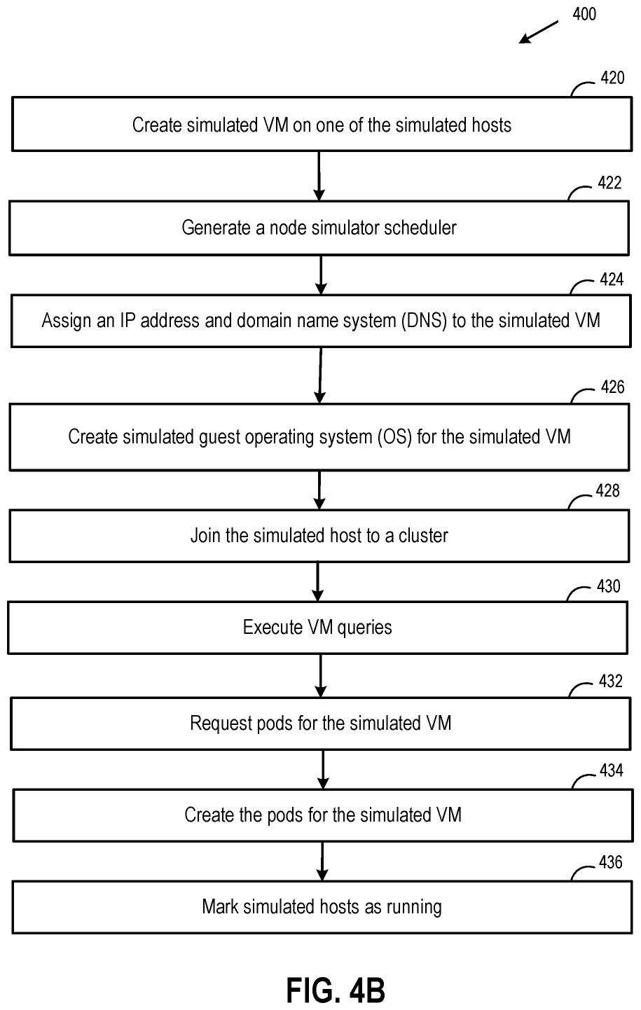

FIG. 3 is a block diagram of simulator 113 in data center 102, according to one or more embodiments. As shown, data center 102 may further include a virtualization simulator operator 302 and automation service 305 (e.g., TCA). Simulator 113, virtualization simulator operator 302 and automation service 305 may be understood with respect to FIGS. 4A-4B below. FIGS. 4A-4B depict a block diagram of a workflow 400 for a simulator with a bridge between a virtualization simulator and a node simulator, according to one or more embodiments. It should be noted that while virtualization simulator operator 302, automation service 305, and simulator 113 are shown in data center 102, the virtualization simulator operator 302, automation service 305, and/or simulator 113 may be implemented as software programs running in a container and/or a VM on computing hardware in data center 102.

As shown, at 402, a virtualization simulator intent is created. In some embodiments, the virtualization simulator intent may be created by a simulator administrator (e.g., via CNI 233). The virtualization simulator intent may initiate creation of virtualization simulator 311. The virtualization simulator intent may specify a number (e.g., thousands) of simulated hosts.

At 404, a topology simulator intent is created by the simulator administrator (e.g., via CNI 233). The topology simulator intent may configure virtualization simulator 311 to handle customizations such as clone VM tasks, VM reconfiguration tasks, VM power on tasks, and VM power off tasks. The topology simulator intent may indicate the topology associated with the simulated hosts. For example, the topology simulator intent may indicate how the hosts and VMs of hosts are connected to virtual and physical components of the data center. In some embodiments, the topology simulator intent indicates resources associated with the hosts to be simulated, such as CPUs, CPU pinning, memory, PCI devices (e.g., Intel acc100 VFs, PTP PFs), VM templates, compute resources, storage resources, virtual switches, distributed switches, port groups, distributed port groups, and/or BYOI template. In some embodiments, the topology simulator intent includes a node simulator scheduler image, a configuration of the node simulator scheduler, and secrets (e.g., an API token) associated with the node simulator scheduler. The topology intent provides a bridge so that the virtualization simulator has knowledge of the host topology.

At 406, the virtualization simulator intent and the topology simulator intent are specified to the virtualization simulator operator 302 to create virtualization simulator 311. Virtualization simulator operator 302 monitors simulator intents and sees the virtualization simulator and topology simulator intents. The virtualization simulator 311 may run on pod VMs 134 in data center 102.

At 408, virtualization simulator operator 302 invokes the virtualization simulator 311 to simulate hosts based on virtualization simulator intent and topology intent. In some embodiments, using one or more PCI devices the hosts can be copied and replayed into simulator memory. Virtualization simulator 311 creates the specified number (N) of simulated hosts, indicated by the virtualization simulator intent, with the specified topology indicated by the topology simulator intent. In some embodiments, creating the simulated hosts (e.g., cell site hosts) includes simulating the associated compute resources, storage, virtual switches, distributed switches, port groups, distributed port groups, and BYOI template. As shown in FIG. 3, virtualization simulator 311 simulates hosts 130(1) . . . 130(N) in simulation cluster 312. The simulated hosts 130(1) . . . 130(N) are created as managed objects of virtualization simulator 311. The simulated hosts 130(1) . . . 130(N) can handle real queries (e.g., associated with a software development kit (SDK)) and/or API calls.

At 410, a node pool creation intent is created. In some embodiments, a cluster administrator defines the node pool creation intent based on the simulated hosts and host resources. In some embodiments, the node pool creation intent specifies the mock resources in virtualization simulator 311. For example, the node pool creation intent may specify resource pool information, VM template information, number of CPUs, and amount of memory. In some embodiments, for a telecommunications vRAN, a TCA cluster administrator consumes the simulated host resources to create a cell site node pool creation intent for RAN CNFs. A node pool is a group of nodes within a cluster that all have the same configuration.

At 412, the node pool creation intent is provided to a cluster operator 308. Cluster operator 308 monitors node pool creation intents and sees the node pool creation intent. In some embodiments, cluster operator 308 manages node simulator cluster 320. In some embodiments, cluster operator 308 is associated with automation service 305. For example, for a telecommunications vRAN, the cluster operator 308 may be a TCA cluster operator associated with a TKG management cluster.

At 414, cluster operator 308 generates a node pool manifest (or manifests) based on the node pool creation intent. The node pool manifest may be a configuration file that describes a pod's containers' connections to other objects (e.g., services or controllers).

At 416, cluster operator 308 provides the node pool manifests to cluster API 207. In some embodiments, cluster API 207 is associated with the automation service 305. In some embodiments, cluster API 207 is a CapV manager associated with the TKG management cluster.

At 418, cluster API 207 requests virtualization simulator 311 to create a simulated VM. In some embodiments, the simulated VMs include cloned VMs, reconfigured VMs, and/or powered on VMs in the simulated hosts 130(1) . . . 130(N). In some embodiments, cluster API 207 requests virtualization simulator 311 to create the clone VMs with a cloud configuration. The cloud configuration may include API server information and authentication information. In some embodiments, the authentication information includes a certification hash (e.g., a caCert hash) and a token (e.g., a kubeadm bootstrap token).

Referring now to FIG. 4B, at 420, virtualization simulator 311 creates a simulated VM (e.g., simulated VM 132(1)) and associates the simulated VM with one of the simulated hosts 130(1) . . . 132(N). In some embodiments, virtualization simulator 311 persists the cloud configuration associated with the simulated VM 132(1).

Virtualization simulator operator 302 monitors VM property changes in virtualization simulator 311 and sees the simulated VM 132(1). At 422, virtualization simulator operator 302 automatically generates a node simulator scheduler 310(1). In some embodiments, the virtualization simulator operator generates node simulator schedulers 310(1) . . . (310(N) for each of the simulated hosts 130(1) . . . 130(N).

At 424, node simulator scheduler 310(1) simulates a DHCP server to assign an IP address and DNS to the simulated VM 132(1). The assignment of the IP address enables IPAM for the simulated VMs.

In some embodiments, node simulator scheduler 310(1) is configured to define simulated guest OS logic (e.g., for guest OS 313(1) . . . 313(N) for simulated VMs 132(1) . . . 132(N)) to virtualization simulator 311. At 426, node simulator scheduler 310(1) creates a simulated guest OS 313(1) for the simulated VM(1). In some embodiments, node simulator scheduler 310(1) creates a pod such as virtual kubelet or a lite VM such as kubeadm, tdnf (a default packet manager in Photon OS), a tuned-adm (e.g., a command line tool that enables switching between TuneD profiles), etc., to simulate the guest OS logic. In some embodiments, node simulator scheduler 310(1) provides the simulated guest OS 313(1) with the node IP address, DNS name, and API server 202 information (e.g., API server token).

At 428, the simulated guest OS 313(1) executes a join command (e.g., a kubeadm join command) to join the simulated host 130(1) to a real target cluster (e.g., a Kubernetes cluster) via the real API server 202. In some embodiments, the VM name and API token is used to join the cluster in networking environment 100.

At 430, CPI 235 executes VM queries handled at virtualization simulator 311 to check the VM existence and remove node taint. In some embodiments, CPI 254 executes the VM queries via cluster API 207. In some embodiments, CPI 235 executes the VM query FindByDNSName or FindByIP to check the VM existence and to remove node taint. Because an IP address and DNS were assigned to the simulated VM 132(1), at step 424, the query for simulated VM 132(1) will be successful.

At 432, CSI 238 and/or CNI 233 requests the simulated guest OS 313(1) to create pods for the simulated VM 132(1) via API server 202. A DaemonSet may be described in a YAML file. A DaemonSet ensures that nodes run a copy of a pod. As nodes are added to the cluster, pods are added to the nodes. A DaemonSet may run a cluster storage daemon, a logs collection daemon, and/or a node monitoring daemon on every node. Deleting a DaemonSet will clean up pods removed from the cluster.

At 434, guest OS 313(1) creates a pod for simulated VM 132(1). In some embodiments, guest OS 313(1) handles other CSI 238 and/or CNI 233 events (e.g., API calls).

In some embodiments, after pod creation, guest OS 313(1) marks the pods as running. Then, at 436 cluster API 207 marks the simulated host 130(1) as ready. In some embodiments, cluster operator 308 then marks the node pool as ready.

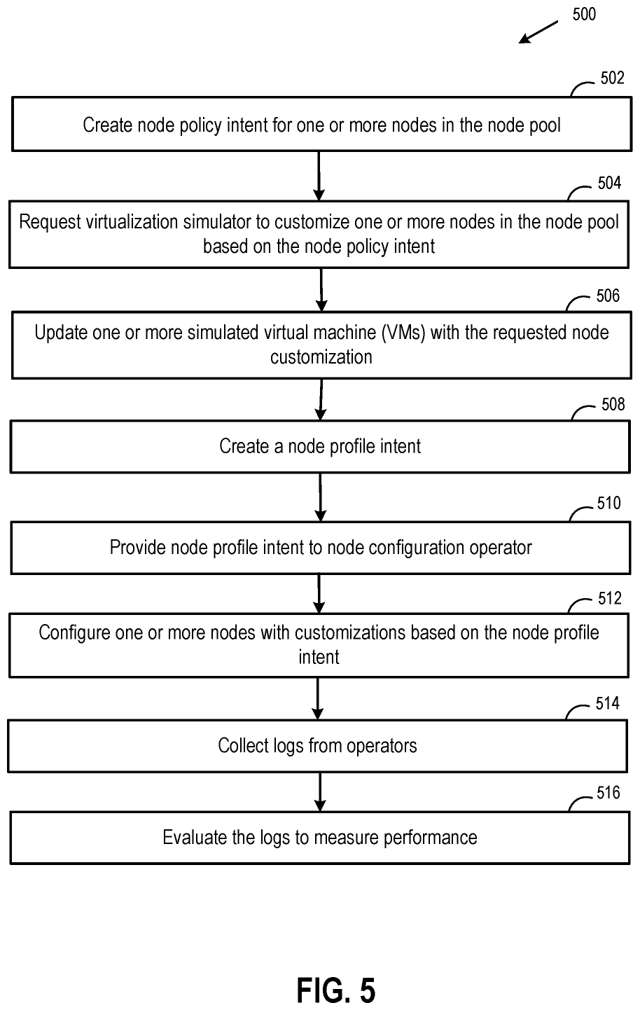

FIG. 5 depicts a block diagram of a workflow 500 for cell site node customization and performance measurement in a vRAN simulation, according to one or more embodiments. In some embodiments, the workflow 500 may performed after the workflow 400 illustrated in FIGS. 4A-4B.

At 502, a node policy intent is created for one or more nodes in the node pool. In some embodiments, in a vRAN scenario, a network function (NF) administrator specifies node customizations for VMs and guest OSs in the node pool intent. In some embodiments, the node pool intent instantiates a CNF (e.g., a 5G DU CNF) in the node pool via the TKG management cluster.

Virtual machine configuration operator 306 monitors node policy intents and sees the node policy intent. In some embodiments, virtual machine configuration operator 306 is associated with automation service 305. At 504, virtual machine configuration operator 306 requests virtualization simulator 311 to customize one or more nodes in the node pool based on the node policy intent. In some embodiments, virtual machine configuration operator 306 communicates with virtualization simulator 311 to fetch CPU and PCI device information of the simulated hosts 130(1) . . . 130(N), to specify shutdown, reconfiguration of a VM 132, selection of one or more SRIOV network adapters, CPU pinning, memory pinning, power on, etc., for one or more of the simulated VMs 132(1) . . .132(N). In some embodiments, reconfiguration of a VM includes reconfiguration of a VM with additional CNIs. In some embodiments, the node customization includes selection of an SRIOV VF as a PCI passthrough device.

At 506, virtualization simulator 311 updates the simulated VMs 132(1) . . . 132(N) with the requested node customization. In some embodiments, virtualization simulator 311 updates corresponding settings based on the requests from the virtual machine configuration operator 306. In some embodiments, updating a simulated VM includes obtaining SRIOV VFs from a PCI physical function (PF) on one of the simulated hosts 130(1) . . . 130(N).

At 508, virtual machine configuration operator 306 creates a node profile intent for one or more nodes in the node pool. In some embodiments, the node profile intent includes simulated guest OS customizations.

At 510, virtual machine configuration operator 306 provides the node profile intent to a node configuration operator 304. In some embodiments, node configuration operator 304 is associated with automation service 305.

At 512, node configuration operator 304 configures the one or more nodes with customizations based on the node profile intent. In some embodiments, configuring the one or more nodes with the customizations includes configuring one or more of the simulated guest OSs 313(1) . . . 313(N) with customizations via API server 202. In some embodiments, the guest OS handling logic defined in the topology simulator intent is used for the simulated guest OS customizations. In some embodiments, the guest OS customization includes Linux-rt kernel installation, StallD, TuneD, Linux PTP, DPDK kernel modulation installation, and/or other guest OS customizations.

In some embodiments, after the simulated guest OS customization, the node configuration operator 304 sets the guest OS customization as complete. In some embodiments, after guest OS customization is complete, CNF helm chart installation may begin. In Kubernetes, a helm chart manages Kubernetes applications. The helm chart helps define, install, and upgrade Kubernetes applications.

In some embodiments, an auditor can measure the performance of the simulated system. At 514, a log processor and forwarder service (e.g., such as fluent Bit) can be used to collect logs from operators. In some embodiments, the log processor and forwarder service collects logs from CaaS operators, such as cluster operator 308 and virtual machine configuration operator 306.

At 516, the logs are evaluated by the auditor to measure the performance of the simulated system.

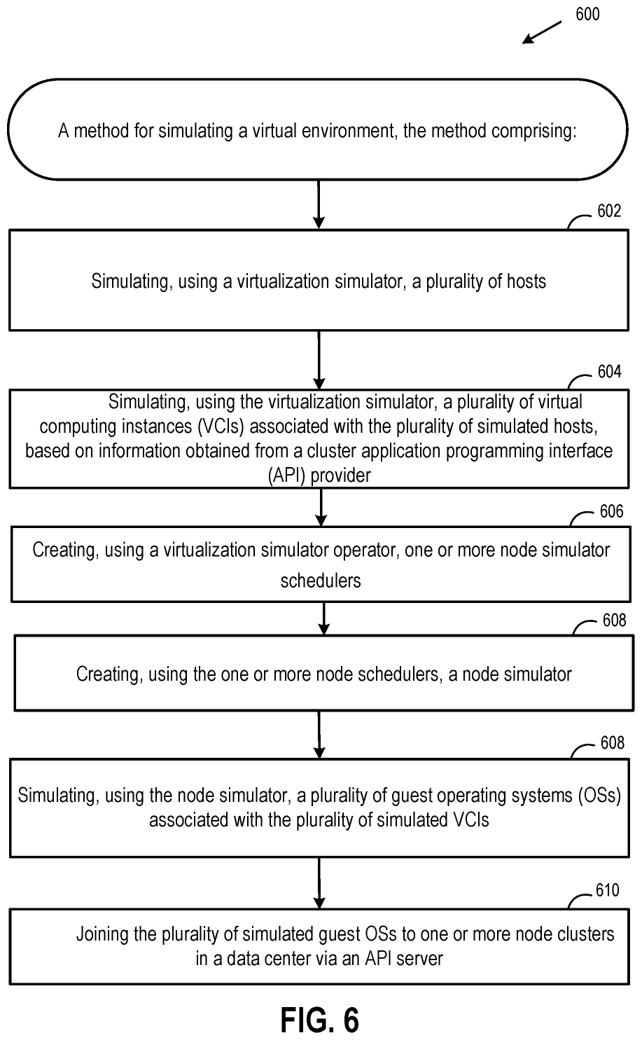

FIG. 6 depicts an example call flow illustrating operations 600 for simulating a virtual environment (e.g., network environment 100), according to one or more embodiments. Operations 600 may be performed by a simulator (e.g., simulator 113).

Operations 600 may begin, at 602, by simulating, using a virtualization simulator (e.g., virtualization simulator 311), a plurality of hosts (e.g., simulated hosts 130).

Operations 600 include, at 604, simulating, using the virtualization simulator, a plurality of VCIs (e.g., simulated VMs 132) associated with the plurality of hosts.

Operations 600 include, at 606, creating, using a virtualization simulator operator, one or more node simulator schedulers (e.g., node simulator scheduler 310).

Operations 600 include, at 608, creating, using the one or more node schedulers, a node simulator.

Operations 600 include, at 610, simulating, using the node simulator, a plurality of guest OSs (e.g., simulated guest OSs 313) associated with the plurality of simulated VCIs.

Operations 600 include, at 612, joining the plurality of simulated guest OSs to one or more node clusters (e.g., host cluster 120) in a data center (e.g., data center 102) via an API server (e.g., API server 202).

Operations 600 may include obtaining, at the virtualization simulator operator, from a user or administrator of the virtualization simulator, a virtualization simulator intent and a topology simulator intent. The virtualization simulator intent may indicate a number of hosts to simulate and the topology simulator intent may indicate at least one of: compute resources, storage resources, virtual switches, virtual port groups, or a VCI template. Operations 600 may include simulating the plurality of hosts based on the virtualization simulator intent and the topology simulator intent. The information from the cluster API provider cluster applications may comprise one or more configurations of the plurality of VCIs. The one or more configurations may include one or more simulated VCIs to clone, one or more simulated VCIs to reconfigure, one or more simulated VCIs to power on, one or more simulated VCIs to power off, a cloud configuration, or a combination thereof. The cloud configuration may include information of the API server, a token for authenticating to the API server, or a combination thereof.

Creating the node simulator, at 608, may comprise simulating, by the node simulator scheduler, a virtual kubelet pod or a light VM. Operations 600 may include providing, by the node simulator scheduler, the virtualization simulator and the virtual kubelet pod or light VM with an assigned IP address associated with the plurality of simulated VCIs and the plurality of simulated guest OSs, a DNS associated with the plurality of simulated VCIs and the plurality of simulated guest OSs, information of the API server, a token for authenticating to the API server, or a combination thereof. Joining the plurality of simulated guest OSs to the one or more node clusters, at 612, may include providing the IP addresses and the token to the API server.

Operations 600 may include, after joining the plurality of guest OSs to the one or more node clusters, obtaining, at the virtualization simulator, from a CPI (e.g., CPI 235), a query for one or more of the plurality of VCIs. The query may include one or more of the IP addresses associated with one or more of the plurality of VCIs.

Operations 600 may include after joining the plurality of guest OSs to the one or more node clusters, obtaining, at the plurality of simulated guest OSs, from at least one of: a CPI, a CSI (e.g., CSI 238), or a CNI (e.g., CNI 233), via the API server, pod configuration information. Operations 600 may include configuring, by the plurality of simulated guest OSs, one or more pods based on the pod configuration information.

Operations 600 may include obtaining, at the virtualization simulator, from a VM configuration operator (e.g., VMConfig Operator 306), a node profile intent indicating one or more VCI customizations. The one or more VCI customizations include shutdown, power on, network adapter reconfiguration, CPU pinning, memory pinning, peripheral component interconnect (PCI) device selection for one or more of the plurality of simulated VCIs, or a combination thereof. Operations 600 may include updating, by the virtualization simulator, the one or more of the plurality of simulated VCIs based on the one or more VCI customizations.

Operations 600 may include obtaining, at a node configuration operator (NodeConfig Operator 304), from a VM configuration operator, a guest OS customization intent indicating one or more guest OS customizations for one or more of the plurality of simulated guest OSs. The one or more guest OS customizations include a kernel configuration, a starvation prevent daemon, a kernel tuning configuration, one or more BIOS settings, a firmware configuration, a driver configuration, a FEC accelerator card configuration, a PTP device configuration, or a combination thereof. Operations 600 may include updating the one or more of the plurality of simulated guest OSs via the API server based on the one or more guest OS customizations.

In some embodiments, the plurality of hosts are associated with a plurality telecommunications cell sites. In some embodiments, one or more of plurality of VCIs each runs a CNF associated with the telecommunications cell sites.

The embodiments described herein provide a technical solution to a technical problem associated with large scale simulation, testing, and automation. More specifically, implementing the embodiments herein provides a bridge between a virtualization simulator and a node simulator. The bridge enables simulated hosts, VMs, and guest OSs to be associated. Further, IP address management is provided for the simulated hosts, VMs, and guest OSs. The simulated hosts, VMs, and guest OSs can then handle events (e.g., API, CPI, CSI, CNI events). The embodiments herein may further provide automation of the simulator. In some embodiments, a user of the simulator only needs to specify two intents for simulation of a large scale. In some embodiments, the embodiments herein may provide for simulation and testing of a vRAN, such as 5G CNFs.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for simulating a virtual environment, the method comprising:
simulating, using a virtualization simulator, a plurality of hosts;
simulating, using the virtualization simulator, a plurality of virtual computing instances (VCIs) associated with the plurality of simulated hosts, based on information obtained from a cluster application programming interface (API) provider;
creating, using a virtualization simulator operator, one or more node simulator schedulers;
creating, using the one or more node schedulers, a node simulator;
simulating, using the node simulator, a plurality of guest operating systems (OSs) associated with the plurality of simulated VCIs; and
joining the plurality of simulated guest OSs to one or more node clusters in a data center via an API server.

2. The method of claim 1, further comprising:
obtaining, at the virtualization simulator operator, from a user or administrator of the virtualization simulator, a virtualization simulator intent and a topology simulator intent, wherein the virtualization simulator intent indicates a number of hosts to simulate and the topology simulator intent indicates at least one of: compute resources, storage resources, virtual switches, virtual port groups, or a VCI template; and
simulating the plurality of hosts based on the virtualization simulator intent and the topology simulator intent.

3. The method of claim 1, wherein:
the information from the cluster API provider cluster applications comprises one or more configurations of the plurality of VCIs;
the one or more configurations include one or more simulated VCIs to clone, one or more simulated VCIs to reconfigure, one or more simulated VCIs to power on, one or more simulated VCIs to power off, a cloud configuration, or a combination thereof; and
the cloud configuration includes information of the API server, a token for authenticating to the API server, or a combination thereof.

4. The method of claim 1, wherein creating the node simulator comprises simulating, by the node simulator scheduler, a virtual kubelet pod or a light virtual machine (VM).

5. The method of claim 4, further comprising:
providing, by the node simulator scheduler, the virtualization simulator and the virtual kubelet pod or light VM with an assigned Internet Protocol (IP) address associated with the plurality of simulated VCIs and the plurality of simulated guest OSs, a domain name service (DNS) associated with the plurality of simulated VCIs and the plurality of simulated guest OSs, information of the API server, a token for authenticating to the API server, or a combination thereof; and
wherein joining the plurality of simulated guest OSs to the one or more node clusters includes providing the IP addresses and the token to the API server.

6. The method of claim 5, further comprising:
after joining the plurality of guest OSs to the one or more node clusters, obtaining, at the virtualization simulator, from a cluster provider interface (CPI), a query for one or more of the plurality of VCIs, wherein the query includes one or more of the IP addresses associated with one or more of the plurality of VCIs.

7. The method of claim 1, further comprising:
after joining the plurality of guest OSs to the one or more node clusters, obtaining, at the plurality of simulated guest OSs, from at least one of: a cluster provider interface (CPI), a cluster storage interface (CSI), or a cluster network interface (CNI), via the API server, pod configuration information; and
configuring, by the plurality of simulated guest OSs, one or more pods based on the pod configuration information.

8. The method of claim 1, further comprising:
obtaining, at the virtualization simulator, from a virtual machine (VM) configuration operator, a node profile intent indicating one or more VCI customizations, wherein the one or more VCI customizations include shutdown, power on, network adapter reconfiguration, central processing unit (CPU) pinning, memory pinning, peripheral component interconnect (PCI) device selection for one or more of the plurality of simulated VCIs, or a combination thereof; and
updating, by the virtualization simulator, the one or more of the plurality of simulated VCIs based on the one or more VCI customizations.

9. The method of claim 1, further comprising:
obtaining, at a node configuration operator, from a virtual machine (VM) configuration operator, a guest OS customization intent indicating one or more guest OS customizations for one or more of the plurality of simulated guest OSs, wherein the one or more guest OS customizations include a kernel configuration, a starvation prevent daemon, a kernel tuning configuration, one or more basic input/output system (BIOS) settings, a firmware configuration, a driver configuration, a forward error correction (FEC) accelerator card configuration, a precision time protocol (PTP) device configuration, or a combination thereof; and
updating the one or more of the plurality of simulated guest OSs via the API server based on the one or more guest OS customizations.

10. The method of claim 1, wherein:
the plurality of hosts are associated with a plurality telecommunications cell sites; and
the plurality of VCIs each runs a containerized network function (CNF) associated with the telecommunications cell sites.

11. The method of claim 1, wherein simulating the plurality of hosts, the plurality of VCIs, and the plurality of guest OSs comprises storing one or more object inventories, one or more data structures, or both specifying the plurality of hosts, the plurality of VCIs, and the plurality of guest OSs.

12. A system comprising:
one or more processors; and
at least one memory, the one or more processors and the at least one memory configured to:
simulate, using a virtualization simulator, a plurality of hosts;
simulate, using the virtualization simulator, a plurality of virtual computing instances (VCIs) associated with the plurality of simulated hosts, based on information obtained from a cluster application programming interface (API) provider;
create, using a virtualization simulator operator, one or more node simulator schedulers;
create, using the one or more node schedulers, a node simulator;
simulate, using the node simulator, a plurality of guest operating systems (OSs) associated with the plurality of simulated VCIs; and
join the plurality of simulated guest OSs to one or more node clusters in a data center via an API server.

13. The system of claim 12, the one or more processors and the at least one memory configured to:
obtain, at the virtualization simulator operator, from a user or administrator of the virtualization simulator, a virtualization simulator intent and a topology simulator intent, wherein the virtualization simulator intent indicates a number of hosts to simulate and the topology simulator intent indicates at least one of: compute resources, storage resources, virtual switches, virtual port groups, or a VCI template; and
simulate the plurality of hosts based on the virtualization simulator intent and the topology simulator intent.

14. The system of claim 12, wherein:
the information from the cluster API provider cluster applications comprises one or more configurations of the plurality of VCIs;
the one or more configurations include one or more simulated VCIs to clone, one or more simulated VCIs to reconfigure, one or more simulated VCIs to power on, one or more simulated VCIs to power off, a cloud configuration, or a combination thereof; and
the cloud configuration includes information of the API server, a token for authenticating to the API server, or a combination thereof.

15. The system of claim 12, wherein the one or more processors and the at least one memory are configured to create the node simulator by simulating, by the node simulator scheduler, a virtual kubelet pod or a light virtual machine (VM).

16. The system of claim 15, the one or more processors and the at least one memory configured to:
provide, by the node simulator scheduler, the virtualization simulator and the virtual kubelet pod or light VM with an assigned Internet Protocol (IP) address associated with the plurality of simulated VCIs and the plurality of simulated guest OSs, a domain name service (DNS) associated with the plurality of simulated VCIs and the plurality of simulated guest OSs, information of the API server, a token for authenticating to the API server, or a combination thereof; and
wherein the one or more processors and the at least one memory configured to join the plurality of simulated guest OSs to the one or more node clusters by providing the IP addresses and the token to the API server.

17. The system of claim 16, the one or more processors and the at least one memory configured to:
after joining the plurality of guest OSs to the one or more node clusters, obtain, at the virtualization simulator, from a cluster provider interface (CPI), a query for one or more of the plurality of VCIs, wherein the query includes one or more of the IP addresses associated with one or more of the plurality of VCIs.

18. The system of claim 12, the one or more processors and the at least one memory configured to:
after joining the plurality of guest OSs to the one or more node clusters, obtain, at the plurality of simulated guest OSs, from at least one of: a cluster provider interface (CPI), a cluster storage interface (CSI), or a cluster network interface (CNI), via the API server, pod configuration information; and
configure, by the plurality of simulated guest OSs, one or more pods based on the pod configuration information.

19. The system of claim 12, the one or more processors and the at least one memory configured to:
obtain, at the virtualization simulator, from a virtual machine (VM) configuration operator, a node profile intent indicating one or more VCI customizations, wherein the one or more VCI customizations include shutdown, power on, network adapter reconfiguration, central processing unit (CPU) pinning, memory pinning, peripheral component interconnect (PCI) device selection for one or more of the plurality of simulated VCIs, or a combination thereof; and
update, by the virtualization simulator, the one or more of the plurality of simulated VCIs based on the one or more VCI customizations.

20. A non-transitory computer-readable medium comprising instructions that, when executed by one or more processors of a computing system, cause the computing system to perform operations for simulating a virtual environment, the operations comprising:
simulating, using a virtualization simulator, a plurality of hosts;
simulating, using the virtualization simulator, a plurality of virtual computing instances (VCIs) associated with the plurality of simulated hosts, based on information obtained from a cluster application programming interface (API) provider;
creating, using a virtualization simulator operator, one or more node simulator schedulers;
creating, using the one or more node schedulers, a node simulator;
simulating, using the node simulator, a plurality of guest operating systems (OSs) associated with the plurality of simulated VCIs; and
joining the plurality of simulated guest OSs to one or more node clusters in a data center via an API server.
